(19) United States
(12) Patent Application Publication
(10) Pub. No.: US 2007/0144842 A1
(43) Pub. Date: Jun. 28, 2007

(54) Vibration control system

(75) Inventor: Jun Zhou, Shenzhen (CN)

Correspondence Address: EDWARDS ANGELL PALMER & DODGE LLP, P.O. BOX 55874, BOSTON, MA, 02205, US

(73) Assignee: REACTEC LTD, Livingston (GB)

(21) Appl. No.: 10/569,305

(22) PCT Filed: Aug. 20, 2004
(86) PCT No.: PCT/GB04/03595

§ 371 Date: Oct. 12, 2006

(30) Foreign Application Priority Data
Aug. 20, 2003 (GB) 0319552.6

(51) Int. Cl. F16F 15/03

(52) U.S. Cl. 188/267

(57) ABSTRACT

A variable damper with a low off-state, having an outer member including a magnetic sleeve and an inner shaft, between which is supported an electromagnet. Magnetorheological fluid is inserted between the members and a flow path is established over a control region between the electromagnet and the sleeve. Various embodiments of the damper are presented with the electromagnet supported on the outer member and on the shaft. A vibration control system incorporating a magnetorheological fluid variable damper is presented wherein the system provides a relative figure of merit for vibration control of at least 0.83. Devices incorporating the damper in a vibration control system are presented for snow boards, clubs, drills, engines, pumps, generators and vehicles.

The present invention relates to improvements in or relating to vibration control, and in particular to a variable damper, a vibration control system incorporating a variable damper and to a method of variably damping relative motion between two members.

There are many situations where it is desirable to control or damp the motion between two objects. One way of doing so is to use a magnetorheological device, as described for example in U.S. Pat. No. 2,575,360. Magnetorheological fluid (MRF) contains a suspension of paramagnetic particles, such that when a magnetic field is applied, the particles align with the field thus effectively increasing the viscosity of the fluid.

A magnetorheological device typically contains an electromagnet which generates a magnetic field when current is passed through its coil. One moving part can be enclosed within an MRF chamber such that when the magnetic field is applied, there is opposition to relative motion of that moving part with another moving part.

U.S. Pat. No. 5,492,312 describes a magnetorheological device wherein a bolt and baffle plate assembly is contained within an MRF chamber, the fluid in which can have a magnetic field applied to oppose relative motion between the assembly and an outer housing, thus damping motion in up to six degrees of freedom. An electromagnetic coil is formed around the outer periphery of the device.

However, design considerations have thus far limited the application of magnetorheological devices for use in devices where the forces that need to be controlled are relatively high. For a device to support applications such as those identified, the off-state force, namely the minimum force required to induce relative motion between the movable parts, needs to be low. This is difficult to keep low because of the high density of the MRF, which can only be reduced at the expense of its damping effectiveness when a magnetic field is applied.

Furthermore an electromagnet can be variably controlled such that the magnetorheological device provides varying levels of damping. However, for such control to be properly refined, there is a requirement that the forces that would be expected to be applied to the device in use fall within the force bandwidth, namely the off-state force and the opposition force provided when the electromagnet is fully activated.

It is an object of at least one embodiment of the present invention to provide a variable damper having a low or minimal off-state force.

It is a further object of at least one embodiment of the present invention to provide a vibration control system with improved damping.

According to a first aspect of the present invention, there is provided a variable damper comprising;
an outer member including a magnetically conductive sleeve;
an inner member comprising a shaft;
an electromagnet supported between the members;
wherein
a chamber between the outer and inner members is at least partially filled with magnetorheological fluid (MRF), such that when a magnetic field is applied to the chamber, the effective viscosity of the fluid increases such that relative motion of the inner and outer members is opposed;
   the region between the electromagnet and the sleeve defining a control region in which the magnetic field is concentrated.

Preferably the outer member comprises a hollow cylindrical body having two body end surfaces, each in a plane perpendicular to the central axis of the shaft and spaced outwardly from an end of the electromagnet.

Preferably the sleeve is located against an inner surface of the outer member providing an inner sleeve surface centred around the axis of the shaft and spaced outwardly from the electromagnet.

Preferably, in a rest position in which no magnetic field is applied, each body end surface is at a first distance from an end of the electromagnet, and the inner sleeve surface is at a second distance from the electromagnet.

Alternatively the sleeve may have two sleeve end surfaces, each in a plane perpendicular to the central axis of the shaft and spaced outwardly from the electromagnet.

The first and second distances represent variables that define the size and shape of the control region. Here, the distances as measured from the electromagnet are the distances that are relevant. However, the electromagnet may be encased within a housing, and the first and second distances may be more conveniently defined as being the distances between the housing and the surfaces.

Preferably, the first and/or second distances can be minimised in order to reduce at least one degree of freedom of the relative motion of the inner and outer members.

In an embodiment, the electromagnet is supported on the outer member. Preferably the electromagnet is supported by a plurality of struts arranged perpendicular to the shaft. These struts do not interrupt significantly the flow path for the MRF through the control region. The electromagnet is therefore fixed in relation to the outer member.

Bearings may be located between the electromagnet and the shaft for ease of manufacture these bearings will be inert.

In an alternative embodiment, the electromagnet is supported on the inner member.

Preferably, the inner member comprises interconnected first and second shaft portions, the longitudinal axes of which, when the inner and outer members are in a relative rest position, define the centre axis of the damper.

Preferably, a housing comprising the electromagnet is interposed between the first and second shaft portions.

Most preferably, a diaphragm seal portion is provided at each end of the shaft to bound the chamber.

Preferably, the shaft is magnetically inert. Thus only the electromagnet and sleeve need be magnetic. This allows the damper to be made primarily of light weight materials such as Aluminium and the like. Light weight materials decrease the off-state force.

Preferably, the seal portion has an elasticity to allow the inner member to rotate in planes perpendicular to the seal portion.

Optionally, the seal portion has an elasticity to reduce at least one degree of freedom of the relative motion of the inner and outer members.

Preferably, the seal portion comprises a sprung collar and a diaphragm seal.

Preferably, the device comprises an elastic end stop to protect the device from damage induced from vibrations in the case where the electromagnet fails.

The outer member may include a secondary housing at a body end surface. The/each secondary housing may comprise a hollow cylindrical body including an aperture through which the shaft extends. Preferably plastic bearings are located at the/each apertures against the shaft. Preferably also, the/each secondary housing is filled with a fluid such as air. These secondary housings act as supports to assist in providing a single axis damper.

According to a second aspect of the present invention there is provided a method of variably damping relative motion between an outer member including a magnetically conductive sleeve and an inner member, comprising the steps:
(a) supporting an electromagnet between the members such that a flow path exists between the electromagnet and the sleeve;
(b) placing magnetorheological fluid between the members;
(c) applying a minimal magnetic field to the electromagnet;
(d) concentrating the field in the flow path; and
(e) increasing viscosity of the fluid to thereby oppose relative motion of the membranes and create damping with minimal off-state.

According to a third aspect of the present invention, there is provided a vibration control system for reducing vibrations between a first and a second element, a magnetorheological fluid variable damper being located between the elements and operated to cause active damping between the elements, wherein the system has a relative figure of merit of less than 0.83.

The relative figure of merit provides an indication of the reduction in vibration achieved by the system.

Preferably the relative figure of merit is equal to or less than 0.5.

Preferably the magnetorheological fluid variable damper is according to the first aspect.

Preferably the shaft is connected to the first element and the housing is connected to the second element; and the system further comprises a spring located between elements; first and second accelerometers located between the damper and the respective first and second elements; and a control unit for inputting accelerometer values and outputting a small electric current to the electromagnet, to cause active damping between the first and second elements.

Preferably the spring is a coil spring. Advantageously the spring is one or more leaf springs. The leaf springs may be arranged symmetrically around the damper. A ‘c’ ring arrangement of one or more layered leaf springs may be used. Leaf springs provide a controlled damping with a reduction in dimensions of the vibration control system.

Alternatively, the inner and outer members of the damper are configured to be suitable for attachment to components of each element on a device, such that the application of relative forces between the elements results in corresponding forces being applied to the inner and outer members of the damper.

Preferably, a parasitic power generator is incorporated within or on the device to provide the electric current that drives the electromagnet.

Preferably the power generator comprises a plurality of power generating units that are arrayed on the device at points where concentrated load would be expected to be applied to the device when it is put to use.

Preferably, the units comprise piezoceramic material. Optionally, the units could comprise piezoelectric unimorph or bimorph material.

Preferably, the device comprises at least one sensor that detects a variable, the value of which can be used to determine a desired amount of electric current to be applied to the electromagnetic coil.

The current applied to the coil can be varied in order to vary the strength of the magnetic field. In turn, the effective increase in the viscosity of the MRF, and hence the amount of damping between the inner and outer members provided by the damper, is dependent on the strength of the magnetic field. Thus, the desired amount of electric current that is determined when a particular value of the variable is detected can be representative of the desired amount of damping that should be applied given that value.

Preferably an intelligent control unit (ICU) is provided, which is capable of receiving input signals from the sensors and outputting command signals to the damper.

Preferably, an algorithm is used by ICU to determine a desired relationship between the input signals and the command signals.

Preferably, the device is a snowboard, one of the outer member and inner member of the damper is attached to the surface of the board, and the other of the inner member and outer member is attached to a raised portion formed on the board.

Preferably, the centre axis of the device is transversely oriented with respect to the longitudinal axis of the board.

Preferably, the centre axis of the device is parallel with the longitudinal axis of the board.

Preferably, a plurality of dampers are attached to the board. Dampers may be provided which have a mixture of centre axis orientations as above.

Preferably, torsion forks are provided on the board and connected to the inner member of the device to enable control of torsional stiffness of the board.

Preferably, a piezoceramic power generating unit is provided at a binding assembly.

The binding assembly is the point at which a boarder would clip their boots into the board.

Optionally, the device is a golf club, one of the outer member and inner member of the damper is attached to the shaft of the club, and the other of the inner member and outer member is attached to or forms the grip of the club.

Optionally, the device is a handle which is a component of a machine.

Such a “machine” may include, for example, a tennis racket, polo mallet or other sports implement, or may be a household tool such as a power drill, or may be a bicycle or motorcycle, with the device being the handlebar.

Optionally, the device is an engine mount, or pump mount. Such devices are found in pumps, generators, engines, vehicles and the like.

Embodiments of the present invention will now be described, by way of example only, with reference to the accompanying drawings, in which:

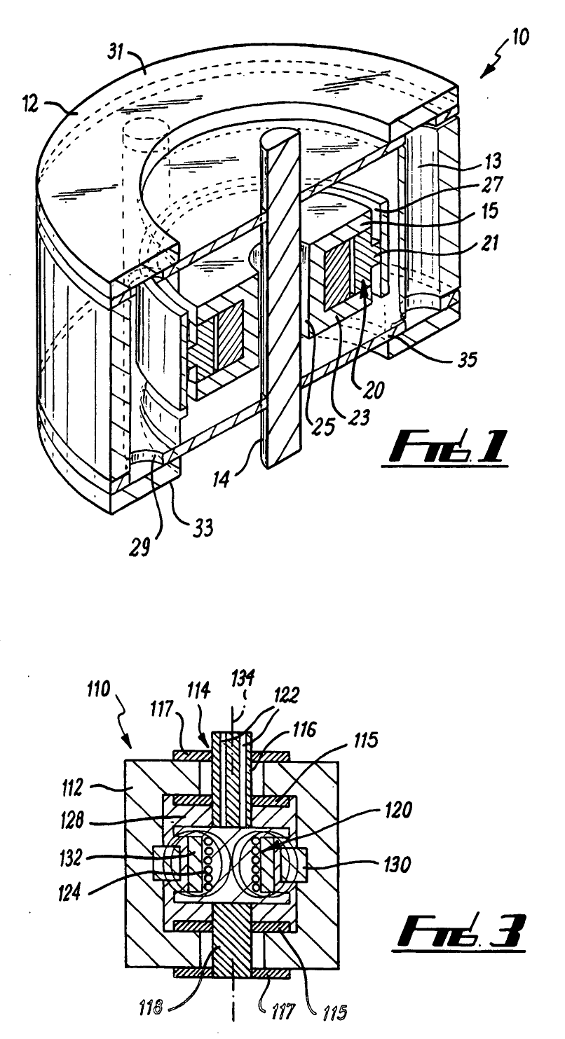

FIG. 1 is an isometric view of a variable damper in accordance with a first embodiment of the present invention;

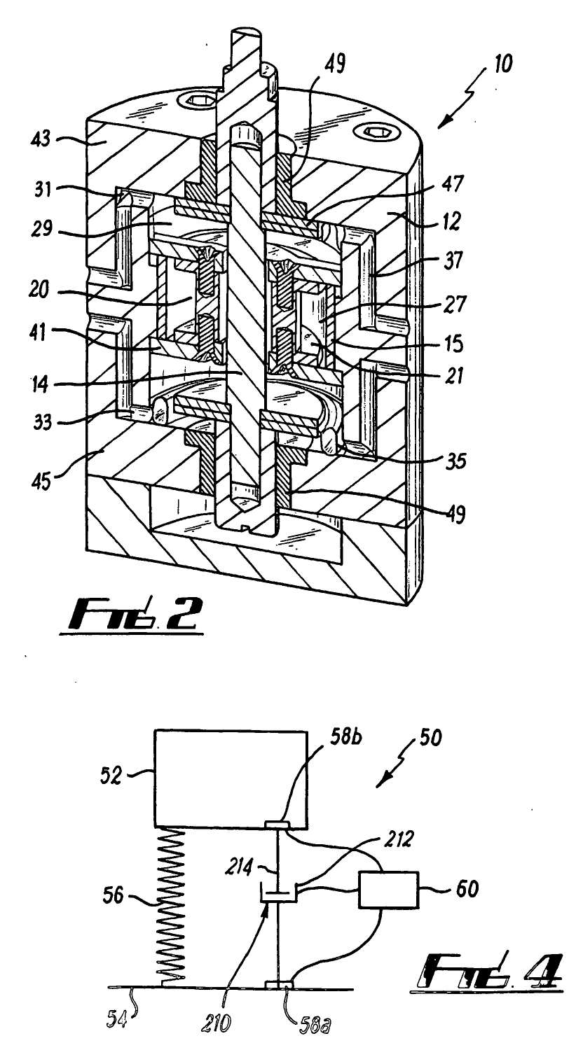

FIG. 2 shows an isometric section of the damper shown in FIG. 1 illustrating the struts supporting the electromagnet;

FIG. 3 shows a sectional view of a variable damper in accordance with a second embodiment of the present invention;

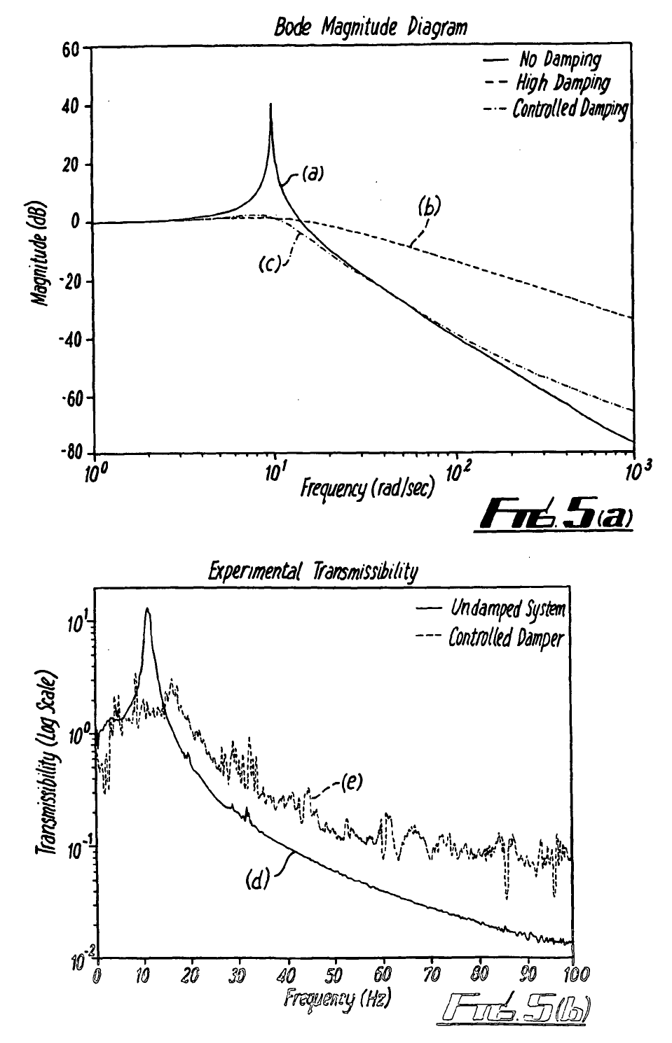

FIG. 4 shows a vibration control system according to an embodiment of the present invention;

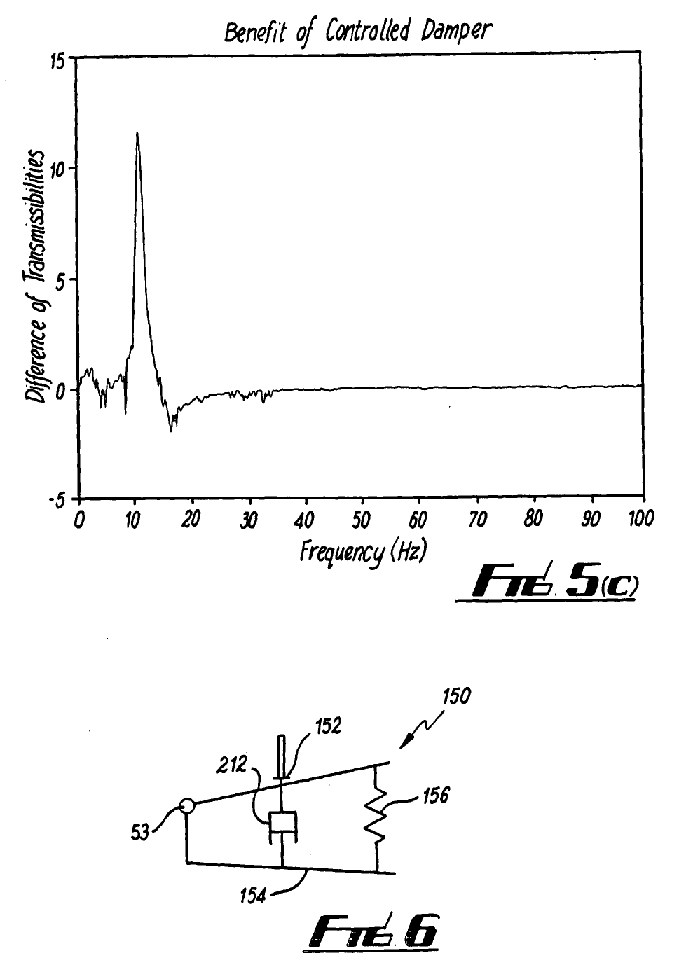

FIG. 5 illustrates response curves for a vibration control system with (a) a theoretical curve of transmissibility against frequency, (b) an experimental curve of transmissibility against frequency and (c) a difference curve from which the relative figure of merit for a system is derived.

FIG. 6 shows a vibration control system according to a further embodiment of the present invention;

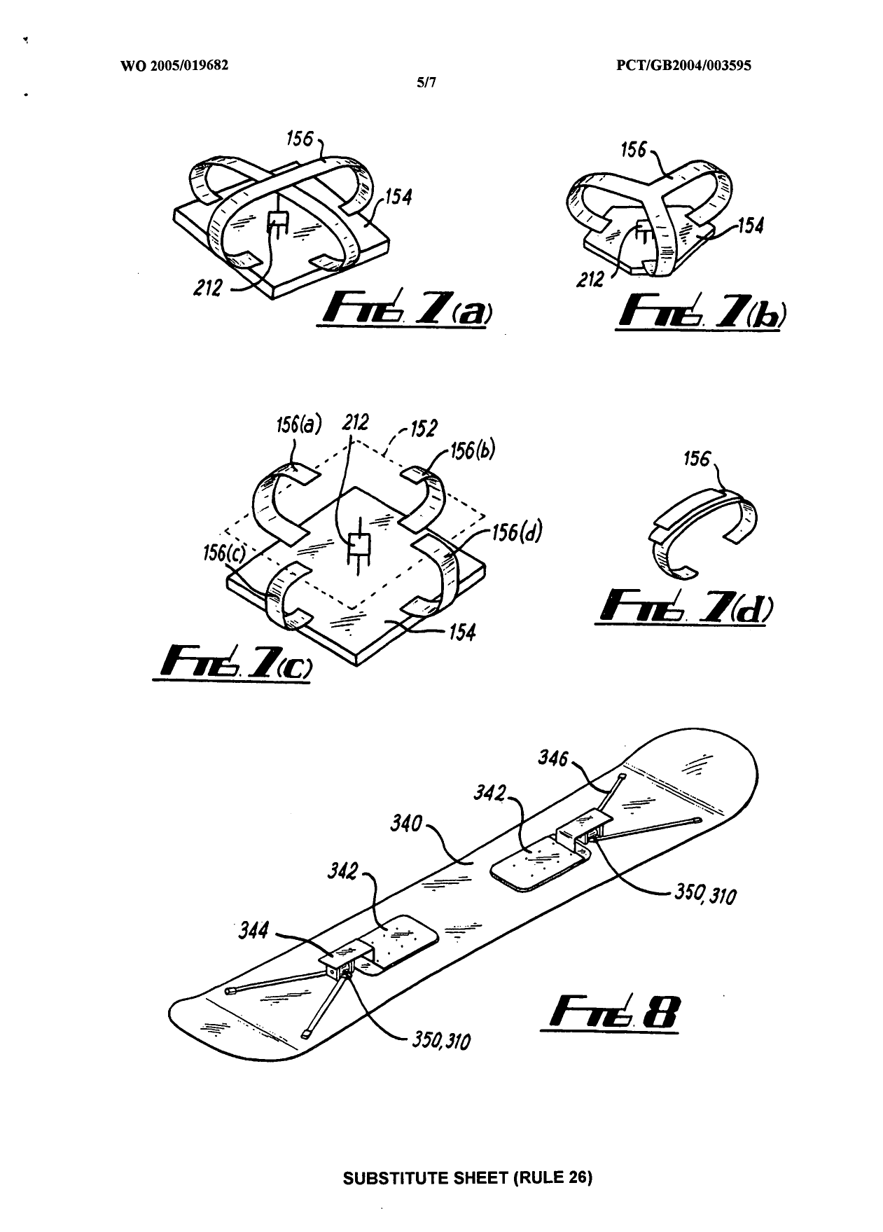

FIGS. 7(a)-(d) show spring arrangements suitable for use on a vibration control system according to an embodiment of the present invention;

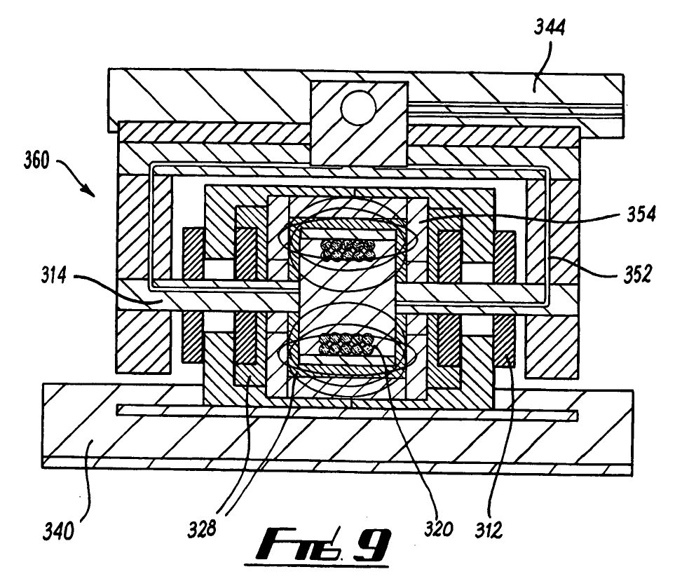

FIG. 8 shows a snowboard incorporating two variable dampers, according to an embodiment of the present invention.

FIG. 9 shows a partial cross sectional view of a variable damper in accordance with a third embodiment of the present invention, mounted longitudinally on a snowboard;

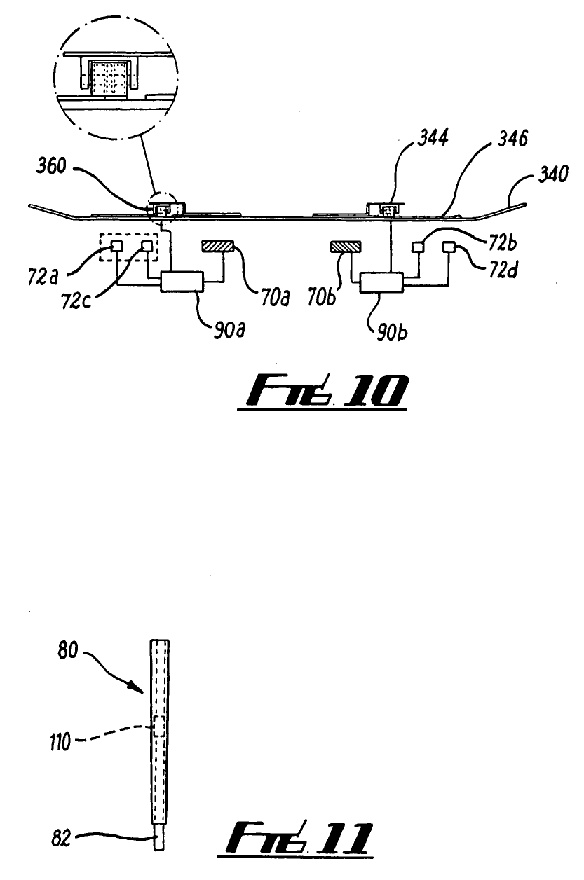

FIG. 10 shows a control schematic for the damper as illustrated in FIG. 9; and

FIG. 11 illustrates a fourth embodiment of a variable damper, as applied for use with a golf club.

Referring initially to FIG. 1 of the drawings, there is illustrated a variable damper, generally indicated by reference numeral 10, according to a first embodiment of the present invention. Damper 10 comprises an outer cylinder 12 and an inner shaft 14. The inner shaft runs symmetrically through the outer cylinder 12. Located within the outer cylinder, against its inner surface 13 there is a sleeve 15. Steel sleeve 15 provides a magnetic flux return guide within the damper 10.

Located within the steel sleeve 15 but independent of the sleeve and of the shaft 14 is electromagnet 20. Electromagnet 20 has a core 21 surrounded by a mount or housing 23, which is magnetically inert. The core housing 23 is supported within the region between the shaft 14 and the sleeve 15 by mounts (not shown) onto the outer cylinder 12. Thus a gap or flow path 25 exists between the shaft 14 and the housing 23, and a flow path 27 exists between the core 21 and the sleeve 15.

The outer cylinder 12 defines a chamber 29 located therein which is bounded at an upper 31 and a lower 33 end by diaphragm seals 35 (only one is shown at the lower end 33). Each diaphragm seal 35 provides a solid collar around the input shaft 14 which extends from the chamber through the diaphragms 35 at either end. It is noted that the shaft 14 is not connected to the EM core 21 although in further embodiments it may be guided with respect to the core, by the incorporation of bearings.

In this embodiment of the present invention, in which diaphragm seals are provided as part of a piston. The seals are connected by the input shaft which runs through the electromagnet.

In use, a control volume 27 of MR fluid is constant between the fixed electromagnet (EM) core 21 and the magnetic flux return guide, sleeve 15. The electromagnet 20 is fixed inside the outer cylinder 12—mounted inside the steel sleeve 15 that acts as the magnetic flux return guide. The input shaft 14 for connection to the vibration source runs through the centre of the EM core 21, with opposing diaphragms 35 connected to the shaft 14 and sealing the system 10. Movement of the input shaft 14 relative to a fixed outer cylinder 12 (connected to the structure to be damped against) results in a pressure change in the MR fluid chamber 29—driving the fluid around the fixed EM core 20, in the annular orifice 27 between the core 20 and the sleeve 15.

Activation of the electromagnet 20 controls the flow of the MR fluid around the electromagnet 20. Increasing power to the electromagnet 20 results in an increase in apparent viscosity of the MR fluid between the EM core 21 and sleeve 15. Exposing the control volume 27 of MR fluid to a variable strength magnetic field enables the control volume 27 to act as a flow control valve. Increasing resistance to fluid flow enables the device to absorb more energy from vibration induced movement of the input shaft 14 relative to the outer cylinder 12.

Connecting the input shaft 14 to opposing diaphragms 35 (with a solid collar around the input shaft 14 at either end, to act as a piston) ensures pressure induced by movement of the input shaft 14 is equal in both directions (i.e., up and down when considering FIG. 1).

The movement of fluid from regions experiencing relatively small magnetic field into the control region 27 helps to reduce degradation in the performance of the fluid (i.e., as a result of in-use-thickening).

One primary and two secondary degrees of freedom can be controlled with the connected diaphragm actuator 10. The primary degree of freedom is with the input shaft 14 reciprocating relative to the outer cylinder 12 (i.e., up and down when considering FIG. 1). Additionally, pitch and yaw about the common central axis of this axis-symmetric actuator can be controlled (i.e., limited rotational movement about two axes orthogonal to the common central axis). This is largely possible due to specification of a diaphragm seal 35, which is a fundamental part of the piston that induces pressure driven flow of the MR fluid around the EM core 20.

The input shaft 14 runs through the electromagnet core 21, but is not connected to it. To achieve control in three degrees of freedom the input shaft is machined from a magnetically inert material, so that its movement is not influenced by the electromagnet.

Control of movement of the input shaft 14 relative to the outer cylinder may be advantageous. This can be achieved by guiding the input shaft through the EM core. A sprung collar/bush between the outside diameter of the input shaft and the inside diameter of the EM core can be specified to control movement of the input shaft against the EM core (i.e., lateral movement when considering FIG. 1).

Additionally, damper mounts located outside on the outer cylinder may be made from rubber and specified to act as an end-stop to prevent movement of the structure connected to the input shaft against the structure to which the outer cylinder is fixed. Therefore, rubber damper mounts around the outer cylinder can act as a mechanical failsafe, should the electromagnet fail. Due to the damage that may be caused should a vibration control system fail, such a mechanical failsafe should be considered a necessity in a number of applications of the device.

By providing a magnetic field across only a small region 27 of the chamber 29, the damper can be operated from a low off-state. This off-state may be typically 10-20 N.

FIG. 2 illustrates the damper of FIG. 1 showing the support means 41 used to locate the electromagnet 20 between the shaft 14 and the cylinder 12. The support means comprises longitudinally arranged struts 41 which connect the cylinder 12 to the housing 23 of the electromagnet 20. These struts 41 merely provide support and do not interrupt MR fluid flow through the region 27 or the return magnetic flux path.

A yet further feature of the damper 10 is illustrated in FIG. 2. In this embodiment, the housing or outer cylinder 12 is extended at each end 31,33 respectively to provide additional supports 43,45. Upper support 43 is a thickening of the end face of the cylinder 12 and is located over the diaphragm seal 35. Thus MR fluid in the chamber 29 is held in, initially by the seal 35 acting on the piston washer 47, and further by the bearing 49 on the support 43. The bearing 49 is plastic and provides a sliding fit against the shaft 14. An identical arrangement is symmetrically arranged at the lower end 33 of the cylinder 12.

FIG. 2 also shows an additional feature which may be incorporated into the damper 10. Airflow channels 37 are machined through the outer cylinder 12 to provide a coolant flow path through the damper 10. In the illustration there are four channels 37 shown, however it will be appreciated that any number can be used, space permitting.

The additional supports 43,45 force the damper 10 to operate on a single axis ie the shaft 14 can only reciprocate on the central axis through the damper 10. This restricted movement of the shaft 14 provides the damper with a low off-state when coupled with the short control region 27.

Reference is now made to FIG. 3 of the drawings which illustrates a second embodiment of the present invention. Like parts of those of FIGS. 1 and 2 have typically been given the same reference numeral with the addition of 100. The variable damper (also called an “actuator” or an “MRF device”) 110 comprises an outer portion 112 and an inner portion 114. The inner portion 14 comprises a first portion 116, second portion 118, and an electromagnet 120. Power lines 122 are provided within the first portion 116 to power the coil 124 of the electromagnet 120.

The first 116 and second 118 portions have seals 115, which, together with an inner surface of the outer portion 112 define an MRF chamber 128. When electric current flows through the electromagnet coil 124, a magnetic field 128 is induced, which has the effect of increasing the effective viscosity of the MRF in the chamber 128, the increase being dependent on the power of current being passed through the coil 124.

Inner seals 115 and outer seals 117 together define the seal portion of the inner member 14. Any suitable form of seal may be used, suitably a diaphragm grommet seal. Additionally the seal portion could be provided by a sprung collar and diaphragm seal at opposite ends of the inner portion, in a similar arrangement to the diaphragm seal 35 and washer 49 of FIG. 2.

Insertion of a sprung collar between the inner axle 114 and outer cylinder 112 provides resistance to movement, proportional to the stiffness of the spring in a particular axis. The MR fluid, electromagnet and sleeve (or cylinder) adds control of dynamic movement.

The sprung collar provides primary control in two axes orthogonal to the central axis and secondary control along the central axis.

In an alternative embodiment, the sprung collar may be replaced by a sprung bush, as is known in the art.

In further alternative embodiments which are not illustrated herein, the sprung collar may have a rectangular or square cross-section.

The incorporation of sprung collars or bushes between the inner axle and outer cylinder has a number of benefits in many applications, including;
1. To resist deflection of the inner relative to the outer up to a specified off state force.
2. To return the inner and outer to their neutral, rest separation.
3. To ensure the inner and outer do not actually touch.
4. To control axial movement.

Items 1 and 3 are conflicting requirements, so therefore, a mechanical end-stop may be additionally specified (to prevent the inner touching the outer), should it not be possible with the same spring to provide a low off state force and ensure clearance is maintained.

The spring constant does not necessarily have to be equal at either end of the cylinder. This presents the opportunity to control axial movement, with resistance to movement (between the inner axle and outer cylinder) at one end of the MRF device being greater or less than the resistance at the other end.

The damper 110 operates in a similar manner to damper 10. Controlling the viscosity of the MRF means that the damping of relative motion between inner and outer portions 12, 14 can be controlled.

A steel (or other magnetically conductive material) sleeve 130 is mounted internally in the outer portion 112, which provides a flux return path through the electromagnet 120 for the magnetic field. This has the effect of concentrating the magnetic field in a region 132 between the inner and outer portions 112, 114, defining a control volume of MRF within the chamber 128 that acts as a control region. It is the variation of the viscosity of this control volume that is critical to controlling the damping. MRF in the remaining volume of the chamber 128 is not activated by the magnetic field when it is applied.

The chamber 128 is bounded by the outer member 112, rather than the sleeve 130. Thus, the volume of the MRF in the device is larger than the control volume.

This ensures that fluid in the control volume can be recycled with fresh fluid as the inner member 114 is moved relative to the outer member 112, the MRF in the control volume being moveable away from the electromagnet to a region of the MRF chamber that is substantially outside the magnetic field. This re-circulation of the fluid reduces the likelihood of fluid-particle separation and in-use thickening, to improve the longevity of the device.

The housing that includes the sleeve 130 can be made from a single component, where the outer housing is made from steel and provides the field return path or up to three components, where the steel sleeve 30 is assembled between split cylinder that makes the outer housing.

This simple construction reduces the number of moving components, making the damper 110 easy to manufacture, and also making it durable.

The electromagnet 120 comprises copper wire wound around a steel core mounted on an inner axle. Therefore, the magnetic flux generator is axis-symmetrically mounted with the MR fluid between it and an outer cylinder to which a steel (or other magnetically conducting material) cylinder is internally mounted—providing a flux return path (to the electromagnet, through the MR fluid).

Mounting the electromagnet on the axle has been considered the most power efficient means of generating magnetic field in the system. Prior devices, in which a coil is wound around the outer cylinder with a magnetically conductive piston mounted on the axle to complete the magnetic circuit, require considerably more power in order to generate a comparable magnetic field with the device thus constructed. However, the arrangement of the electromagnet independently suspended between the axle and the outer cylinder, providing a control region between the electromagnet and the outer cylinder, has been found by the inventors to give a more power efficient means and thus a damper with the lowest possible off-state force. This is the embodiment shown in FIGS. 1 and 2.

The advantage of the embodiment shown in FIG. 3 is that it provides for multi-axis control. Two translational degrees of freedom are provided, as the inner portion 114 translates in a direction along an axis running from left to right of the device 110, or in a direction along an axis extending normal to the page, as illustrated in FIG. 3.

When a magnetic field is applied, the resistance to this relative translational motion that is provided by the MRF is known as a pressure driven flow mode.

Activation of an electromagnet produces an apparent change in viscosity in MRF exposed to the generated magnetic field. As the MR fluid becomes more viscous, more force is required to generate a pressure that causes the fluid to flow around a constriction. The movement of the electromagnet on the inner axle relative to the outer steel sleeve creates a constriction and (pressure driven) fluid flow can be controlled (like a valve) as the electromagnet activates the MR fluid.

There is also a rotational degree of freedom for relative rotation about a central axis 134 of the device 110.

When the two portions 112, 114 attempt to rotate relative to each other in this way, the MRF resists the movement by a shear force that is induced at the surfaces of the chamber 128. This can be known as the direct shear mode of damping control. The strength of resistance to motion offered by the direct shear mode is much less than the strength offered by the pressure driven flow mode.

The inner member 114 comprises a first portion 16, a second portion 118, and a housing containing the electromagnet 120. These portions are integral, and the longitudinal axes of the first and second portions are in-line and define a central axis 34 both of the inner member 114 and the device 10.

Seals 115, 117 provide sufficient elasticity for the shaft of the inner member to rotate about an axis running into and out of the page of the device as illustrated in FIG. 3 (i.e. moving clockwise/anticlockwise in the figure), and about an axis running from left to right horizontally as illustrated in FIG. 3 (i.e. tilting into and out of the page in the figure).

Movement between the inner 114 and outer 116 portions in a direction along the central axis 134 of the device is limited in its extent by the seals.

Spring return to the neutral position results from the viscoelastic property of the seals/with sprung collars located between seals, against the inner and outer (i.e., in the space between the shaft and the outer housing). Thus, the two translations at right angles to the shared central axis (of the inner axle and outer cylinder), plus pitch and yaw about the same axis can be considered as being four primary degrees of freedom that can be controlled, while one translation of the inner member relative to the outer member along the shared axis and one rotation about the same axis (assuming the diaphragm seal is assembled to rotate with the inner axle) can be considered as two secondary degree of freedom can be controlled. The secondary degrees of freedom are limited by the seals.

One advantage of the damper described above lies in its ability to provide control of dynamic movement over a range (i.e. a control bandwidth). The control bandwidth is between the off state (no power to the electromagnet; fluid not activated) and the on state (electromagnet fully on; fluid fully activated).

It is important that off-state force is sufficiently low for the control bandwidth of the MRF device to act over the operating range of the product to which it is fitted. Should the off-state force (required to move the MRF device) be outside or near the upper limit of the operating range, the control bandwidth of the MRF device is of little benefit to the product to which it is fitted, and a passive vibration control solution would be better considered.

A low off state force capability can be achieved by:
1. Reducing the viscosity of the MR fluid, while avoiding significant reduction in the % volume of carbonyl iron content (that would reduce the on state capability).
2. Increasing the gap between the electromagnet and the steel sleeve/cylinder, without increasing the gap to an extent that the magnetic field strength (generated with the electromagnet activated) becomes dissipated—i.e., reducing the on state capability.
3. Specifying seals with sufficient elasticity to maintain the MR fluid stays in the outer cylinder, but avoids significant energy being absorbed by the seals as the inner is forced to move relative to the outer.

The MRF dampers 10,110 of the present invention operate with a low viscosity fluid to ensure a low off state force is maintained. Concerns with settling and in-use-thickening (where the activated MR fluid degrades to a paste-like consistency) are significantly reduced if the MR fluid in the control volume and particularly the control region can be re-circulated (i.e., with MR fluid not exposed to the magnetic field). Spaces are provided in the chambers 29,128 on either side of the control region 27,132 for this purpose.

The variable dampers of the present invention have a wide range of applications, and the scope of the invention should not be construed as being limited to a particular application. Thus reference is now made to FIG. 4 which illustrates a vibration control system, generally indicated by reference numeral 50, according to an embodiment of the present invention.

FIG. 4 illustrates a standard vibration control system 50, which controls movement between two moving objects 52 and 54. It will be appreciated that one object eg. item 54, may be static and that all movement is upon the first item 52. Located between the objects 52, 54 is a spring 56. Also located between the two objects is a vibration damper 210. The housing or outer cylinder 212 of the damper is connected to the first object 54 while the inner shaft 214 of the damper 210 is connected to the second object 52.

Further, at positions where the dampers meet the object there is located an accelerometer 58a,b. The accelerometers 58a,b give an indication of the movement each of the objects 52, 54. The output of each accelerometer 58a,b spread to a control unit 60 from which an electrical signal passes to a damper 210 to provide the magnetic field on the magnetorheological fluid within the damper 210. An optimised algorithm is programmed into the control unit 60 onto a microprocessor so that the electrical signal to the damper can be varied in accordance with the values determined from the accelerometers 58a,b.

Damper 210 is as described with reference to FIGS. 1 and 2. While the control unit 50 could use the second embodiment shown in FIG. 3, the single axis damper of FIGS. 1 and 2 is most appropriate. The advantage of using the active damper of FIGS. 1 and 2 is that it provides a low off-state indicated by the transmissibility against frequency curve obtained. This is as indicated in FIG. 5.

Reference is now made to FIG. 5(a) of the drawings, which indicates a theoretical graph showing transmissibility against frequency. Drawn as a Bode Magnitude Diagram of magnitude (dB) against frequency (rad/sec), curve (a) of the graph shows the classic initial peak and trailing edge normalised characteristic of the mass 52 supported by the spring 56 alone and having a resonant frequency fₙ. In the same system with a fixed damper, curve (b), the peak in transmissibility is reduced to near one, however the trailing edge provides a higher transmissibility at the high frequencies. The active damper 210 provides an optimal curve, curve (c), with a low off-state. This curve provides the smoothness to the peak with a transmissibility of close to one, matching that of the fixed damper. On the trailing edge, it has properties close to the ideal properties of the spring at the higher frequencies.

Experimental results taken from a sprung mass system similar to the theoretical one in FIG. 5(a) are plotted in FIG. 5(b) showing the characteristics of both the spring alone, curve (d), and the optimally controlled system, curve (e). The relative normalised transmissibility improvement using the optimally controlled variable damper 212 against the spring only system is shown in difference graph of FIG. 5(c) whereby a positive figure indicates a reduction of vibration. A single figure of relative merit of 0.8229 for this improved system is derived by the ratio of integral of transmissibility from 0→100 Hz for the controlled damper system over integral of transmissibility for the spring only system. The equation for this is given:

$$\frac{{\int }_{0}^{100 Hz} trans ( ControlledDamper )}{{\int }_{0}^{100 Hz} trans ( SpringOnly )}$$

Any comparison to alternative damper designs should be evaluated using the baseline of the spring only graph given in FIG. 5(b) in order that a fair comparison can be made. This means that a system with a replica transmissibility function would need to be used.

It is estimated that with ongoing refinements to the system to improve optimisation, this relative figure of merit can be brought down to 0.5 or better.

The control system of FIG. 4 finds particular application in respect of engine mounts, pump mounts and power tools. The engine block could be mounted at the object marked 52 and thus provides the vibration control for pumps, generators, engines and in vehicle manufacture.

A further embodiment of a vibration control system, generally indicated by reference numeral 150, is illustrated in FIG. 6. Like parts to those have been given the same reference numeral with the addition of 100. The system 150 now incorporates a pivot 53. In this way the load, or first object 152 acts on the damper 212 against the pivot 53. The system 150 may incorporate accelerometers and a control unit as described with reference to FIG. 4.

The spring 156 in this embodiment is formed by leaf springs as distinct from the typical coil spring. These leaf springs can be advantageously arranged around the damper 212 to save space and provide better control to the system 150. A non-exhaustive selection of suitable arrangements is illustrated in FIGS. 7(a)-(d). FIG. 1(a) illustrates a crossed pair over the damper 212. Each spring 156 is in a ‘c’ spring formation with both ends on the second object 154. FIG. 7(b) illustrates a triplet arrangement of three springs, meeting at the first object 152 and distributed across the second object 154. FIG. 7(c) provides a quad arrangement of four independent leaf springs 156(a)-(d) which are symmetrically distributed around the damper 212. FIG. 7(d) illustrates an arrangement for adjusting the resonant frequency of the spring 156 by layering individual leaf springs, creating a progressive type leaf spring. The lowest spring in the configuration is in a ‘c’ spring formation with the additional springs symmetrically aligned on its upper surface.

As a particular example, the invention will now be described as is incorporated in a snowboard.

This application is shown generally in FIG. 8. A board 340 has bindings 342 with shim portions 344, to which the outer portion 312 of a damper (or “actuator”) 310 is attached. The inner portion 314 of the damper 310 is attached to the board 340. Torsion forks 346 are also mounted on the board 340, and are also in communication with the inner portion 314 of the damper 310. The damper 310 primarily as described herein with reference to FIG. 3.

As is described in more detail below, sensors monitor dynamic movement and provide input to an intelligent control unit (ICU) made up of one or more microprocessors. The response (i.e., energy absorbing capability) of the MRF actuator(s) controls dynamic movement of the product with a view to optimising performance/tuning the system to suit the operator player).

The multi-axis damper 310 aims to provide a wide bandwidth of semi-active damping. The system will enable the level of vibration energy absorption to be adapted with respect to vibration impulses (i.e., the product of force and time) and can be tuned to suit the user.

Soft flex, torsionally flexible boards are easier to turn and better to control at lower speeds and are generally better off piste. Stiff, torsionally rigid boards have greater stability at speeds and have enhanced carving ability—making it easier to place the board in a turn at speed. Damper 310 is capable of adapting the characteristics of the board with respect to speed and snow conditions. This is achievable by using integrated sensors to monitor the amplitude and time response of vibrations that can be used to characterise speed and surface condition, with an algorithm programmed into a microprocessor controlling power supply to the electromagnets that adapt the energy absorbing capability of the MRF actuator(s)ie. dampers 310.

The actuator must be mounted so that torsional and longitudinal movement of the board can be transmitted through the actuator.

For a snowboard, the actuator can be mounted with its central axis 334 either transverse or parallel (“in-line”) to the longitudinal axis of the board 340.

FIG. 9 shows a third embodiment of the present invention, namely an actuator 350 that is mounted in line with the board 340. Components of the actuator 360 are similar to the components referred to in FIG. 3 and shall not be hereinafter described in detail. The reference numerals that apply to FIG. 3 can be taken to refer to the corresponding components in FIG. 9 now prefixed ‘3’.

The sprung collar or the bush described with reference to FIG. 3, are not essential parts of the MRF device when it is incorporated in to a snowboard, as the board acts as the spring that is to be controlled. MRF devices with sprung collars or bushes would add to the stiffness matrix of the board and provide adaptive semi-active control of dynamic movement. On the snowboard, the actuator is returned to a neutral position as the board relaxes after being deflected (assuming the board does not become permanently deformed).

The electromagnet 320 is powered by power supply 352 routed through the shim 344. The MRF chamber 328 is attached to the board 340, and the outer portion 312 of the actuator 360 is attached to the shim 344. If the actuator 360 is transversely mounted, the chamber 328 and outer potion 312 are connected to the board 340 and shim 344 also.

Steel sleeve 354 is attached to the outer cylinder 312 of the outer member, and has the shape of a cylindrical body portion with two washer shaped end portions at each end of the cylinder, the outer edges of which are in line with the outside perimeter of the body portion. The electromagnet 320 is mounted on an axle and positioned inside the steel cylinder 354.

The inner axle and outer cylinder share a common axis. There is a defined gap between the electromagnet and the steel cylinder, comprising a first dimension X, being the distance between the end of the electromagnet 320 and the inner wall of the steel cylinder 354, and a second dimension Y, being the distance between the inside diameter of the steel cylinder 354 and the outside diameter of the electromagnet 320.

The gaps as defined by the dimensions X and Y enable the device to control up to six degrees of freedom.

To minimise the off state force, X and Y should be made as large as possible, bearing in mind that their increase will result in a corresponding decrease in the force that can be provided by the device once the full on state is applied.

As shown in FIG. 8, the torsion forks 346 are connected to the inner portion 314, to transmit longitudinal and torsional movement to the MRF actuator.

The MRF actuator 360 can adapt semi-active damping of torsional and longitudinal movement with a combination of the pressure driven flow (/valve mode) and direct shear mode of the MR fluid being applied.

Mounted with its axis parallel to the axis of the board, the MRF actuator can adapt semi-active damping of longitudinal movement with a combination of the pressure driven flow (/valve mode) and direct shear mode of the MR fluid being applied. Torsional stiffness can be adapted by applying the direct shear mode to resist rotation of the inner relative to the outer.

Adaptive control of the damping is provided by an intelligent control system. FIG. 10 shows an intelligent control system 90 suitable for use with the damper 360 shown in FIG. 9. It will be appreciated that a similar control system would be suitable for a transversely mounted actuator.

Integration of a parasitic power generator is preferable to powering the system from a battery. A piezo-ceramic power generator 70 (such as PZT—lead zirconium titanate) located at areas of concentrated load can be used to harvest power from deflections induced by the movement between the rider and the board.

The location of the generator could for example, be specified to be under the riders boot. For example, the power generator could be a piezoelectric (lead-zirconium titanate—PZT) bimorph/piezoelectric (PZT) unimorph located in the minding foot-plate/between the binding assembly and the deck of the board.

This is in contrast to presently available systems, which merely use the vibration caused by movement of the board to generate power. By placing the piezo-ceramic power generators 70 at strategic points where there is concentrated load and/or movement from the rider of the board when using it, enough power can be generated to power the electromagnet and ICU.

The piezo-ceramic generator 70 located within the binding assembly (/between the binding and board) can power an energy efficient network of control-actuator(s).

An array of piezo (polymer) sensors (e.g., polyvinylidenefluoride—PVDF) sensors 72 provides a self-powered vibration monitoring capability. An array of sensors 72 located within the beam section to be controlled can provide input to the control interface on longitudinal and torsional dynamic movement produced from surface induced impulses.

This system must be sufficiently energy efficient so that the power available to the electromagnet can sufficiently change the apparent viscosity of the MR fluid, resulting in a satisfactory improvement in dynamic control. Therefore, the number of turns on the core of the electromagnet must be sufficient to generate a satisfactory on state but be conservative in number to conform to the power constraints. The available energy and required control bandwidth must be considered for each application.

The data provided by the sensors 72 can be used to determine the amplitude and frequency characteristics of board vibration induced as the board 340 moves over the snow. Characteristics of the vibration can be used to determine environmental inputs (e.g., hard/soft packed snow), based on information pre-programmed into the ICU 90.

The ICU 90 controls the power supply to the electromagnet 20 such that vibration amplitude and frequency may be controlled subject to the applied control algorithm (e.g., proportional control/proportional-integral-differential control/sky-hook algorithm/to a set value—up to a definable maximum).

One or more MRF actuators may be mounted transversely, or with its axis parallel to that of the board as described above in order to provide multi-axis control.

Another major application of the present invention is the incorporation of an actuator in the grip of sports equipment, such as for example tennis, squash or badminton rackets; golf clubs; baseball or cricket bats; or polo mallets.

FIG. 11 shows the application of an adaptive shock absorbing grips may integrated on a golf club 80.

The MRF device 110 is integrated so that the axis is in-line with the axis of the shaft 82, with the inner component mounted to the shaft 82 and the outer making up the grip. Activation of the electromagnet mounted on the structural inner component results in an apparent viscosity change in the MR fluid between the inner and outer (grip), reducing relative movement in two axes and introducing an adaptable energy absorbing capability.

A spring return to a neutral position is required. Sprung collars or bushes can be located between the seals against the inner axle and outer cylinder (i.e. in the space between the shaft and the outer housing) to provide resistance to deflection that the MR fluid is able to dynamically control. Therefore the spring is integrated in the damper assembly.

A contact plate can interface the shock-absorbing grip with the sensor-control and power supply elements of the system.

For this application, and application to handles of other devices, it is desirable to actively prevent translation along and rotation about the shared central axis of the inner member relative to the outer member, so the off state force in these degrees of freedom needs to be raised.

This is possible by specifying seals with appropriate elasticity to prevent noticeable movement.

Again, integration of a parasitic power generator is preferable to powering the system from a battery. A piezo-ceramic power generator located at a point of concentrated load can be used to harvest power from deflections induced by the movement between the head or club, the shaft, and the handle (where the grip is located). The piezo-ceramic generator can power an energy efficient network of control-actuator(s), with piezo (polymer) sensors providing self-powered vibration monitoring capability.

PVDF sensors are proposed to provide a self-powered vibration monitoring capability. An array of sensors located within the shaft can provide input to the control interface on transmitted vibrations resulting from shock induced impulses.

A further identified application of multi-axis adaptive semi-active control of dynamic movement is in bicycle and motorbike handles. Sports bikes with low handles result in a riding position that puts weight on the rider's wrists, with fatigue compounded by any shock induced vibration that is not sufficiently damped by the main front suspension. One or more multi-axis MRF device can be located in the bike handles as a secondary system to absorb shock and reduce wrist fatigue.

In a motorcycle application there is sufficient capacity to power the MRF device(s) with negligible performance consequences.

Applied to bicycles, although it is possible, it is advantageous not to power the MRF device(s) from the powertrain (i.e., rotation of the pedals/the wheels) as this will reduce performance. An alternative, to a dynamo powering the MRF device(s) from the powertrain, is a parasitic power generator—preferably located between the bicycle and rider, at a position, where there is a concentrated load.

A piezo-ceramic power generator located in the seat-post can be used to harvest power from deflections induced by the movement of the rider on the seat. The piezo-ceramic generator can power an energy efficient network of control-actuator(s), with piezo (polymer) sensors providing self-powered vibration monitoring capability.

The single axis damper with additional supports provides a damper with the lowest possible off-state. When incorporated in a vibration control system, as could be used on engines, pumps, generators etc, the damper provides a system with an ideal transmissibility against frequency curve.

Improvements and modifications can be made to the above without departing from the scope of the present invention. In particular, the application of the invention to be incorporated in specific devices is not limited to the list of specific devices herein. Furthermore, it will be apparent that the specific geometry of, for example, the layout of the sensor array or of the parasitic power generators may be varied as appropriate for the specific application being considered.

1-24. (canceled)

25. A variable damper comprising;
an outer member including a magnetically conductive sleeve;
an inner member comprising a shaft; and
an electromagnet supported between the members;
wherein:
a chamber formed between the outer and inner members is at least partially filled with magnetorheological fluid (MRF), such that when a magnetic field is applied to the chamber, the effective viscosity of the fluid increases such that relative motion of the inner and outer members is opposed; and
characterized in that the electromagnet is supported in the chamber to provide a first fluid flow path between the outer member and electromagnet, and a second fluid flow path between the inner member and the electromagnet, the region between the electromagnet and the magnetically conductive sleeve defining a control region in the first fluid flow path in which the magnetic field is concentrated.

26. A variable damper as claimed in claim 25, wherein the outer member is located within a first housing.

27. A variable damper as claimed in claim 25, wherein the outer member comprises a first housing.

28. A variable damper as claimed in claim 25, wherein the electromagnet is supported on the outer member, such that the first fluid flow path is maintained between the outer member and the electromagnet.

29. A variable damper as claimed in claim 25, wherein the electromagnet is supported by a plurality of struts arranged perpendicular to the shaft.

30. A variable damper as claimed in claim 25, wherein the electromagnet is supported on the inner member.

31. A variable damper as claimed in claim 30, wherein the inner member comprises interconnected first and second shaft portions between which is arranged a second housing comprising the electromagnet.

32. A variable damper as claimed in claim 25, wherein a diaphragm seal portion is provided at each end of the shaft to bound the chamber.

33. A variable damper as claimed in claim 32, wherein the seal portion has an elasticity to allow the inner member to rotate in planes perpendicular to the seal portion.

34. A variable damper as claimed in claim 32, wherein the seal portion has an elasticity to reduce at least one degree of freedom of the relative motion of the inner and outer members.

35. A variable damper as claimed in claim 25, wherein the outer member includes a third housing at least at one body end surface, the/each third housing comprising a hollow cylindrical body including an aperture through which the shaft extends.

36. A method of variably damping relative motion between an outer member including a magnetically conductive sleeve and an inner member, comprising the steps:
(a) supporting an electromagnet between the members, such that a first flow path exists between the electromagnet and the sleeve, and a second flow path exists between the electromagnet and the inner member;
(b) placing a magnetorheological fluid between the members;
(c) applying a minimal magnetic field to the electromagnet;
(d) increasing the magnetic field in the first flow path; and
(e) increasing viscosity of the fluid to thereby oppose relative motion of the members and create damping with minimal off-state.

37. A vibration control system for reducing vibrations comprising:
a first and a second element; and
a variable damper, located between the first and second elements, including an outer member including a magnetically conductive sleeve; an inner member comprising a shaft; and an electromagnet supported between the members, wherein a chamber formed between the outer and inner members is at least partially filled with magnetorheological fluid (MRF), such that when a magnetic field is applied to the chamber, the effective viscosity of the fluid increases such that relative motion of the inner and outer members is opposed and characterized in that the electromagnet is supported in the chamber to provide a first fluid flow path between the outer member and electromagnet, and a second fluid flow path between the inner member and the electromagnet, the region between the electromagnet and the magnetically conductive sleeve defining a control region in the first fluid flow path in which the magnetic field is concentrated, wherein the vibration control system causes active damping between the elements such that a relative figure of merit of less than 0.83.

38. A vibration control system as claimed in claim 37, wherein the relative figure of merit is less than or equal to 0.5.

39. A vibration control system as claimed in claim 36, wherein the shaft is connected to the first element and the housing is connected to the second element; and the system further comprises a spring located between elements; first and second accelerometers located between the variable damper and the respective first and second elements; and a control unit for inputting accelerometer values and outputting a small electric current to the electromagnet, to cause active damping between the first and second elements.

40. A vibration control system as claimed in claim 36, wherein the inner and outer members of the damper are configured to be suitable for attachment to components of a device, such that an application of relative forces between components results in corresponding forces being applied to the inner and outer members of the damper.

41. A vibration control system as claimed in claim 40, wherein a parasitic power generator is incorporated with the device to provide the electric current that drives the electromagnet.

42. A vibration control system as claimed in claim 40, wherein the device comprises at least one sensor that detects a variable, a value of which can be used to determine a desired amount of electric current to be applied to the electromagnetic coil.

43. A vibration control system as claimed in claim 42, wherein an intelligent control unit (ICU) is provided, which is capable of receiving input signals from the sensors and outputting command signals to the damper, the command signals being derived from an algorithm used to determine a desired relationship between the input signals and the damping required.

44. A vibration control system as claimed in claim 43, wherein the device is a snowboard, one of the outer member and inner member of the damper is attached to a surface board, and the other of the inner member an outer member is attached to a raised portion formed on the snowboard.

45. A vibration control system as claimed in claim 44, wherein a plurality of dampers are attached to the snowboard.

46. A vibration control system as claimed in claim 45, wherein torsion forks are provided on the snowboard and connected to the inner member of the device to enable control of torsional stiffness of the snowboard.

47. A vibration control system as claimed in claim 43, wherein the device is a golf club, one of the outer member and inner member of the damper is attached to a shaft of the golf club, and the other of the inner member and outer member is operatively associated with a grip of the club.

48. A vibration control system as claimed in claim 43, wherein the device is a handle which is a component of a machine, wherein the machine is selected from a group consisting of: a tennis racket, polo mallet, sports implement, a household tool, a power drill, a bicycle, a motorcycle, and like machines.

49. A vibration control system as claimed in claim 43, wherein the device is selected from the group consising of an engine mount, pump mount, and the like.
